(19) United States
(12) Patent Application Publication
(10) Pub. No.: US 2024/0174205 A1
(43) Pub. Date: May 30, 2024

(54) VEHICLE BRAKING SYSTEM

(71) Applicants: Hitachi Astemo Ueda, Ltd., Nagano (JP); Honda Motor Co., Ltd., Tokyo (JP)

(72) Inventors: Kazuaki Miyata, Nagano (JP); Masaki Koike, Tokyo (JP)

(21) Appl. No.: 18/517,278

(22) Filed: Nov. 22, 2023

(30) Foreign Application Priority Data
Nov. 29, 2022 (JP) 2022-190568

(51) Int. Cl. B60T 8/172; B60T 7/12; B60T 8/17; B60T 17/22

(52) U.S. Cl. CPC B60T 8/172; B60T 7/12; B60T 8/1701; B60T 17/22

(57) ABSTRACT

Vehicle braking system includes controller that performs driving control to close a normally-open solenoid valve based on required boosting request, and determination unit that determines whether a braking load upon boosting request is in a steady range. When the braking load upon the boosting request exceeds a predetermined first load threshold, the determination unit determines that the braking load is in a caution range above the steady range. When the braking load upon the boosting request is in the caution range, the controller executes braking control using a first valve closing transient characteristic to close the solenoid valve from the point of occurrence of the boosting request. The first valve closing transient characteristic is set steeper than a second valve closing transient characteristic to close the solenoid valve from the point of occurrence of the boosting request when the braking load upon the boosting request is in the steady range.

### CROSS-REFERENCE TO RELATED APPLICATION

This application claims the benefit of foreign priority to Japanese Patent Application No. 2022-190568, filed on Nov. 29, 2022, which is incorporated by reference in its entirety.

### TECHNICAL FIELD

The present invention relates to a vehicle braking system that applies braking force to a vehicle.

### BACKGROUND

Electric vehicles employ a by-wire brake system, for example, that generates braking force through an electrical system, in addition to an existing brake system that applies braking force through a hydraulic system. In such a by-wire brake system, the amount of operation of a brake pedal by a driver is converted into an electric signal, which is applied to an electric actuator to drive a piston of a slave cylinder (hereinafter referred to as a “motor cylinder device”).

The electric actuator then operates to drive the piston, thus generating brake fluid pressure in the motor cylinder device. The brake fluid pressure thus generated activates wheel cylinders, thereby applying braking force to a vehicle (see, for example, a vehicle brake system disclosed in JP2012-131438A). A by-wire vehicle brake system according to JP2012-131438A can apply braking force to a vehicle through an electrical system.

In the by-wire vehicle brake system according to JP2012-131438A, a solenoid valve of a type that drives a plunger connected to a valve toward a valve closed position against spring force of a return spring is provided in a hydraulic passage that communicates a master cylinder with a motor cylinder device. The solenoid valve then shuts off a primary hydraulic pressure generated in the master cylinder in accordance with a brake operation by a driver, and a secondary hydraulic pressure is generated in the motor cylinder device in accordance with a brake pedal operation amount. As for the type of solenoid valve, a normally open type is used for the purpose of ensuring fail-safe operation.

To close the normally-open solenoid valve, power supply is required to maintain the plunger, which receives the reaction force of the return spring, in a closed position and generate necessary thrust to close the valve. When power is supplied to the solenoid valve, collision noise is generated between the plunger and a case when the plunger reaches the valve closed position. When the plunger is returned to its initial position after stopping the power supply, again, collision noise is generated between the plunger and the case when the plunger reaches the initial position due to the spring force of the return spring.

To reduce such collision noise, the by-wire vehicle brake system according to JP2012-131438A includes a control device that controls opening and closing of the solenoid valve in accordance with brake operation. This control device carries out control to gradually increase a supply current to the solenoid when driving the plunger toward the valve closed position. For convenience of explanation, such control will be referred to as silent control. This silent control suppresses the speed of the plunger when reaching the valve closed position.

According to the by-wire vehicle brake system according to JP2012-131438A, the collision noise (noise) generated by the operation of the solenoid valve can be reduced by the silent control suppressing the speed of the plunger when reaching the valve closed position.

However, in the by-wire vehicle brake system according to JP2012-131438A, the silent control suppresses the speed of the plunger when reaching the valve closed position. This impairs the responsiveness of the solenoid valve. As a result, there is a time delay in shutting off the hydraulic passage, and the degree of consistency related to the correlation between the braking operation amount and generated braking force is impaired.

Here, when a braking performance evaluation system that evaluates braking performance based on the degree of consistency related to the correlation is adopted, there is a risk that the braking performance evaluation system erroneously evaluate that the braking performance has deteriorated, in a driving scene with a large braking load such as going down a long downhill road, for example.

The present invention has been made in view of the above-mentioned circumstances, and an object thereof is to provide, even when a braking performance evaluation system that evaluates braking performance based on the degree of consistency related to correlation between braking operation amount and generated braking force is adopted, a vehicle braking system that can prevent as much as possible the braking performance evaluation system from erroneously evaluating braking performance as poor.

### SUMMARY

In order to achieve the above object, an invention according to (1) is a vehicle braking system for applying braking force to an own vehicle, including: a master cylinder device that generates a primary hydraulic pressure according to a braking operation by a driver; a motor cylinder device that generates a secondary hydraulic pressure according to a target braking force by activating an electric actuator in response to a required boosting request; a normally-open solenoid valve which is provided in a hydraulic pressure passage that communicates between the master cylinder device and the motor cylinder device, and operates to open or close the hydraulic pressure passages; and a controller that performs driving control to close the solenoid valve based on the required boosting request, the vehicle braking system further comprising: a determination unit that determines whether or not a braking load upon a boosting request is in a steady range, wherein
when the braking load upon the boosting request exceeds a predetermined first load threshold, the determination unit determines that the braking load is in a caution range above the steady range,
when the braking load upon the boosting request is in the caution range, the controller executes braking control using a first valve closing transient characteristic to close the solenoid valve from the point of occurrence of the boosting request, and
the first valve closing transient characteristic is set steeper than a second valve closing transient characteristic to close the solenoid valve from the point of occurrence of the boosting request when the braking load upon the boosting request is in the steady range.

### BRIEF DESCRIPTION OF THE DRAWINGS

The drawings described herein are for illustration purposes only and are not intended to limit the scope of the present invention in any way.

FIG. 1 is a schematic configuration diagram of a vehicle braking system according to an embodiment of the present invention.

FIG. 2 is a block diagram showing a configuration including an ESB-ECU, an integrated ECU, and their peripherals included in the vehicle braking system according to the embodiment of the present invention.

FIG. 3 is a flowchart for explaining operations of the vehicle braking system according to the embodiment of the present invention.

FIG. 4 is a time chart for explaining the operations of the vehicle braking system according to the embodiment of the present invention.

FIG. 5 is an explanatory diagram showing a comparison between an operation of a vehicle braking system according to a comparative example of the present invention and the operation of the vehicle braking system according to the embodiment of the present invention.

### DETAILED DESCRIPTION

A vehicle braking system according to an embodiment of the present invention will be hereinafter described in detail with reference to the accompanying drawings.

In the drawings described below, members having common functions or members having mutually corresponding functions are, in principle, denoted by common reference numerals. For convenience of explanation, sizes and shapes of members may be schematically deformed or exaggerated.

### [Overview of Vehicle Braking System 11 According to Embodiment of Present Invention]

First, an overview of a vehicle braking system 11 according to the embodiment of the present invention will be described. The vehicle braking system 11 according to the embodiment of the present invention executes braking control using a first valve closing transient characteristic that, when a braking load Tpad upon a boosting request is in a caution range above a steady range, solenoid valves 60a and 60b are closed at the point of occurrence of the boosting request. The first valve closing transient characteristic is set steeply compared to a second valve closing transient characteristic that, when the braking load Tpad upon a boosting request is in the steady range, the solenoid valves 60a and 60b are closed at the point of occurrence of the boosting request.

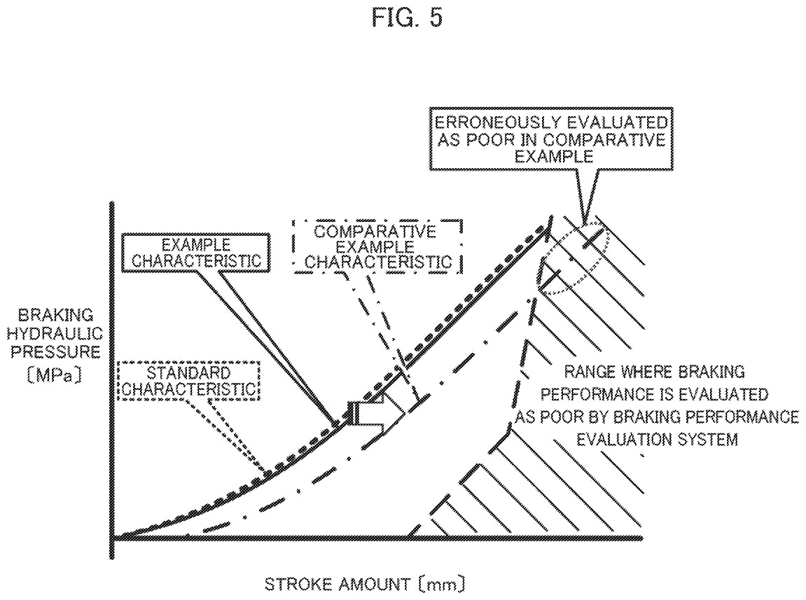

Thus, even when a braking performance evaluation system is adopted to evaluate braking performance based on the degree of consistency concerning the correlation between a brake operation amount and generated braking force, the braking performance evaluation system can be prevented as much as possible from erroneously evaluating braking performance as poor (see FIG. 5).

Hereinafter, the vehicle braking system 11 according to the embodiment of the present invention will be sequentially described in detail.

### [Schematic Configuration of Vehicle Braking System 11 According to Embodiment of Present Invention]

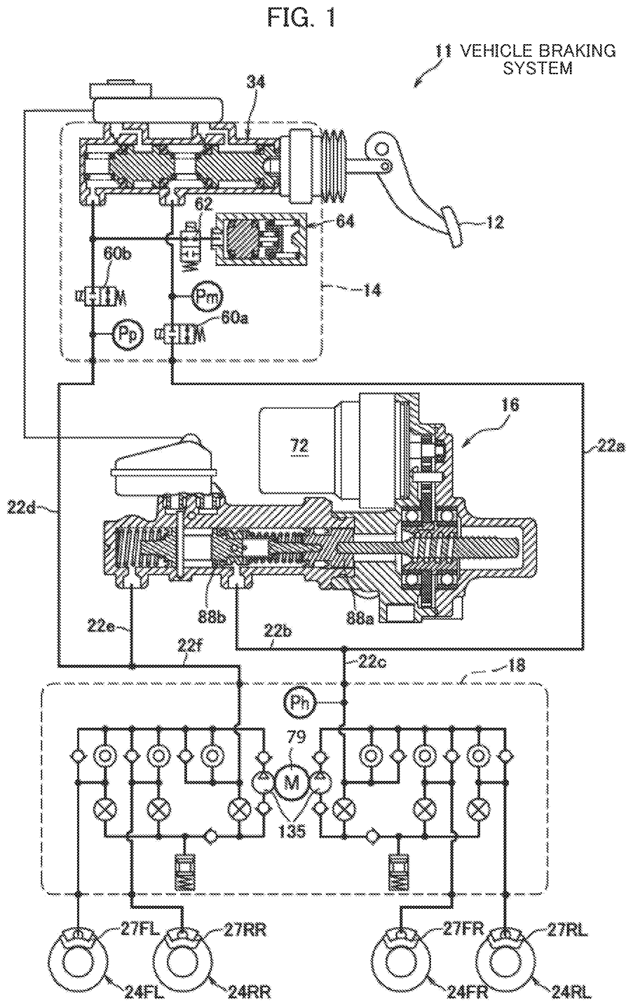

Next, a schematic configuration of the vehicle braking system 11 according to the embodiment of the present invention will be described with reference to FIG. 1. FIG. 1 is a schematic configuration diagram of the vehicle braking system 11 according to the embodiment of the present invention.

The vehicle braking system 11 includes a by-wire brake system that generates braking force through an electrical system, in addition to an existing brake system that generates braking force through a hydraulic system.

As shown in FIG. 1, the vehicle braking system 11 includes a master cylinder device 14, a motor cylinder device 16, a vehicle stability assist device 18 (hereinafter referred to as the “VSA device 18”, VSA being a registered trademark), and hydraulic braking mechanisms 24FR, 24RL, 24RR, and 24FL.

The hydraulic braking mechanisms 24FR, 24RL, 24RR, and 24FL, when collectively referred to, are abbreviated as the “hydraulic braking mechanisms 24”.

The master cylinder device 14 has a function to generate a primary hydraulic pressure in accordance with a brake operation through a brake pedal 12 by a driver of own vehicle (not shown). To realize this function, the master cylinder device 14 includes: a master cylinder 34 that converts the driver's brake operation inputted through the brake pedal 12 into the primary hydraulic pressure; a stroke simulator 64 that creates a pseudo reaction force against the brake pedal 12 operated by the driver; and first to third shut-off valves 60a, 60b, and 62.

The first and second shut-off valves 60a and 60b correspond to “solenoid valves” of the present invention. The functions of the first and second shut-off valves 60a and 60b will be described in detail later.

The motor cylinder device 16 has a function to generate a secondary hydraulic pressure according to a target braking force (target braking torque) by operating a brake motor (electric actuator) 72. To realize this function, the motor cylinder device 16 includes a pair of slave pistons 88a and 88b that generate the secondary hydraulic pressure in response to rotational driving force of the brake motor 72.

The VSA device 18 has a function to provide support for stabilizing the behavior of the own vehicle. Specifically, as shown in FIG. 1, the VSA device 18 operates a pump motor 79 according to the behavior of the own vehicle, and increases and decreases (adjusts) the secondary hydraulic pressure by driving a pump 135 in conjunction with this operation.

By exerting such functions, the VSA device 18 has an ABS function to suppress wheel locking during brake operation by periodically increasing and decreasing the secondary hydraulic pressure, a traction control system (TCS) function to suppress wheel idling during acceleration, and a function to suppress sideslip when turning.

The hydraulic braking mechanisms 24 have a function to brake four wheels (not shown) of the own vehicle. The hydraulic braking mechanism 24 includes calipers 27FR, 27RL, 27RR, and 27FL.

The calipers 27FR, 27RL, 27RR, and 27FL, when collectively referred to, are abbreviated as the “calipers 27”.

The calipers 27 brake the four wheels by sandwiching discs (not shown) provided on the four wheels, respectively, using the primary hydraulic pressure generated by the master cylinder device 14 or the secondary hydraulic pressure generated by the motor cylinder device 16.

Reference numerals Pm, Pp, and Ph are brake hydraulic pressure sensors that detect the pressure of a braking fluid (brake fluid) flowing through hydraulic passages 22a to 22f.

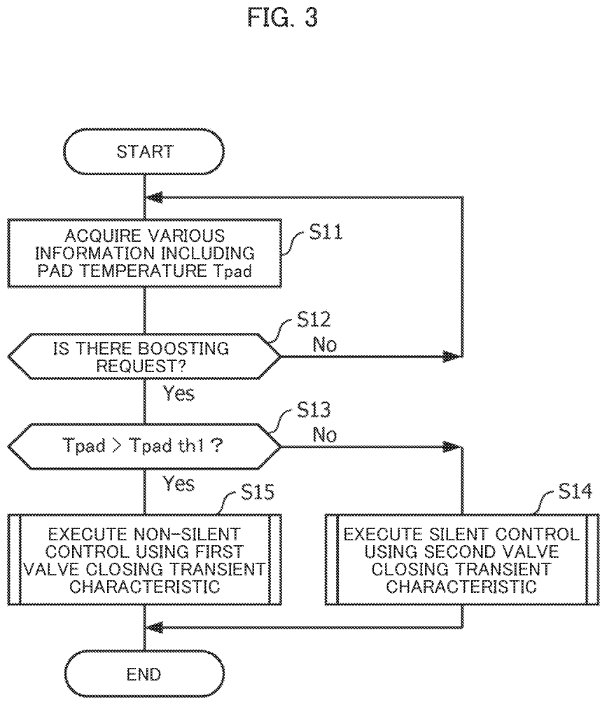

In the vehicle braking system 11 thus configured, the first and second shut-off valves 60a and 60b are each a solenoid valve of a type that drives a plunger connected to the valve toward a valve closed position against spring force of a return spring (not shown), as with the valve described in JP2012-131438A (see FIG. 3 of Japanese Patent Application Laid-open No. 2012-131438).

The first and second shut-off valves 60a and 60b are provided so as to be interposed in the hydraulic passages 22a and 22d that communicate between the master cylinder device 14 and the motor cylinder device 16. The first and second shut-off valves 60a and 60b are formed of normally-open solenoid valves that operate to open or close the hydraulic passages 22a and 22d.

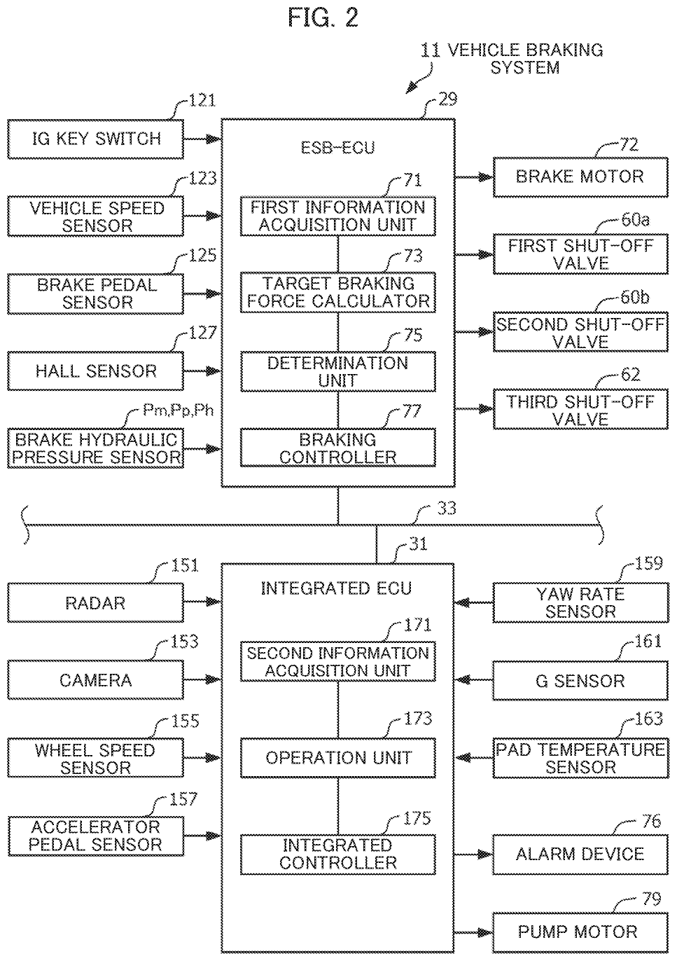

In the vehicle braking system 11, an ESB-ECU 29 and an integrated ECU 31 (see FIG. 2; to be described in detail later), upon receipt of a boosting request, use the first and second shut-off valves 60a and 60b to shut off the primary hydraulic pressure generated in the master cylinder device 14 according to the driver's brake operation. At the same time, the brake motor 72 of the motor cylinder device 16 is used to generate a secondary hydraulic pressure corresponding to the brake operation amount.

In short, in the vehicle braking system 11, the ESB-ECU 29 and the integrated ECU 31 shut off (close) the first and second shut-off valves 60a and 60b upon receipt of the boosting request. Then, with the first and second shut-off valves 60a and 60b, which have been shut off, as boundaries, the primary hydraulic pressure is generated on the master cylinder device 14 side that is the upstream side, while the secondary hydraulic pressure is generated on the motor cylinder device 16 side that is the downstream side.

The operation of the vehicle braking system 11 upon receipt of no boosting request is as follows. Specifically, the ESB-ECU 29 and the integrated ECU 31 supply no power to the first and second shut-off valves 60a and 60b upon receipt of no boosting request. As a result, the first and second shut-off valves 60a and 60b are opened. Then, in response to a driver's brake operation, the primary hydraulic pressure generated on the master cylinder device 14 side, which is the upstream side, is transferred to the motor cylinder device 16 side, which is the downstream side, through the opened first and second shut-off valves 60a and 60b.

Upon receipt of the boosting request, the ESB-ECU 29 and the integrated ECU 31 have two systems of members having a function to adjust the secondary hydraulic pressure while the first and second shut-off valves 60a and 60b are shut off.

One is a first system to adjust the secondary hydraulic pressure by adjusting slide positions of the pair of slave pistons 88a and 88b using the rotational driving force of the brake motor 72.

The other is a second system to adjust the secondary hydraulic pressure by driving the pump 135 in conjunction with the operation of the pump motor 79.

As for the function to adjust the secondary hydraulic pressure, the second system using the pump motor 79 is generally more responsive than the first system using the brake motor 72.

### [Definition of Terms Used in This Specification]

Here, terms used in this specification to describe the vehicle braking system 11 are defined.

The “silent control” means control to suppress collision noise generated between plungers (not shown), which are provided in the first and second shut-off valves 60a and 60b, and a case when the plungers reach the valve closed position, by slowly and gradually increasing the supply current to the solenoid over time (making the slope (rate of change) of aging characteristics gentler) when driving the plungers toward the valve closed position.

There are roughly two situations where a “boosting request” occurs. The first is a boosting request that occurs in accordance with the driver's brake operation. The second is a boosting request generated by control of the integrated ECU 31 based on information concerning a driving situation of the own vehicle, regardless of the driver's brake operation. Specifically, the integrated ECU 31 outputs a required boosting request, for example, when the vehicle speed of the own vehicle exceeds a set value while performing constant speed travel control related to adaptive cruise control (ACC), or when the distance from a preceding vehicle is less than a set value while performing following travel control related to the ACC.

The “braking load” in the vehicle braking system 11 is, for example, a brake pad temperature Tpad that is the temperature of a brake pad provided in a disc brake. The brake pad temperature Tpad is a value detected by a pad temperature sensor 163. As the pad temperature Tpad, a value estimated based on parameters such as the vehicle speed and lateral G of the own vehicle may be adopted, for example.

The “brake pad temperature correlation value” is a concept that includes both the detected value of the brake pad temperature Tpad by the pad temperature sensor 163 and the estimated value of the brake pad temperature Tpad.

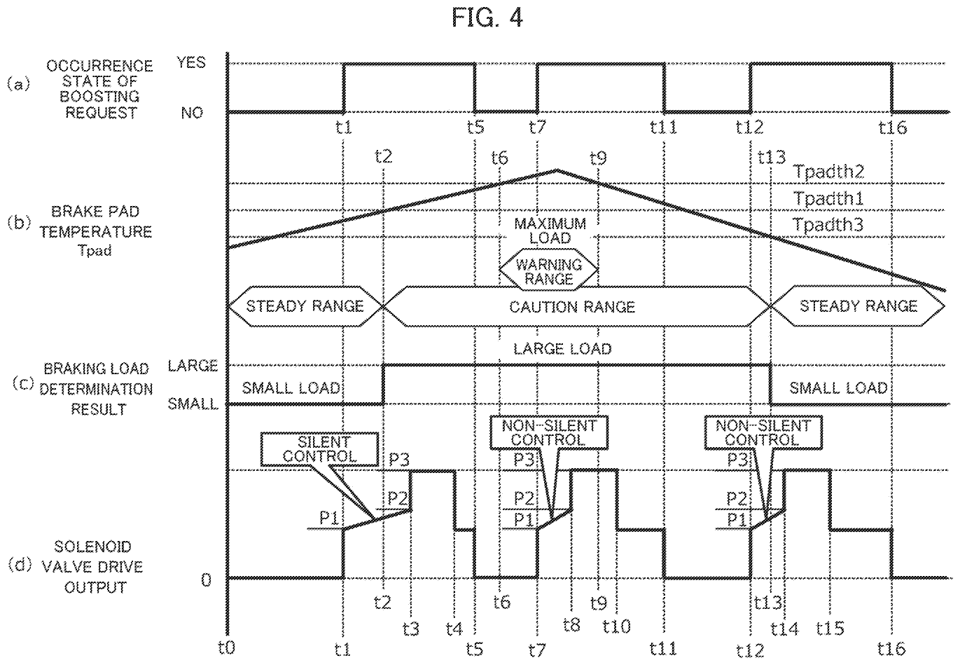

As shown in FIG. 4, a first load threshold Tpadth1 is a threshold that serves as a reference for determining, when the brake pad temperature Tpad (braking load) is in a steady range where the brake pad temperature Tpad is in a steady state, whether or not the brake pad temperature Tpad has transitioned from the steady range to a caution range that requires caution.

As shown in FIG. 4, a second load threshold Tpadth2 is a threshold that serves as a reference for determining, when the brake pad temperature Tpad is in the caution range, whether or not the brake pad temperature Tpad has transitioned from the caution range to a warning range (stricter than the caution range) where passengers need to be warned. The brake pad temperature Tpad is used as an evaluation parameter in the braking performance evaluation system. When the brake pad temperature Tpad exceeds the second load threshold Tpadth2, the braking performance evaluation system determines that the vehicle braking system 11 has poor braking performance, considering that the braking load is at its maximum. On the other hand, when the brake pad temperature Tpad exceeds the first load threshold Tpadth1 (Tpadth1<Tpadth2), the vehicle braking system 11 according to the embodiment prohibits the predetermined silent control and executes non-silent control, considering that the braking load is large.

As shown in FIG. 4, a third load threshold Tpadth3 is a threshold that serves as a reference for determining, when the brake pad temperature Tpad is in the caution range, whether or not the brake pad temperature Tpad has transitioned from the caution range to the steady range.

The third load threshold Tpadth3, which serves as the reference for determining whether or not the brake pad temperature Tpad has transitioned from the caution range to the steady range, is set to be smaller than the first load threshold Tpadth1, which serves as the reference for determining whether or not the brake pad temperature Tpad has transitioned from the steady range to the caution range. This is to prevent the occurrence of a so-called hunting phenomenon that the brake pad temperature Tpad transitions between the steady range and the caution range in a short period of time.

As for the vehicle braking system 11, unless otherwise specified, a case will be described by way of example where a boosting request occurs in the integrated ECU 31 based on information concerning the driving condition of the own vehicle.

### [Basic Operations of Vehicle Braking System 11 According to Embodiment]

Next, basic operations of the vehicle braking system 11 according to the embodiment will be described.

In the vehicle braking system 11, when the motor cylinder device 16 is in a normal state and the ESB-ECU 29 and integrated ECU 31 (see FIG. 2) which perform by-wire control are in a normal state, for example, the by-wire brake system is activated by the driver stepping on the brake pedal 12 to perform a braking operation.

In the vehicle braking system 11 under normal conditions, when the driver performs a braking operation (however, the same applies to a case where, regardless of the driver's braking operation, a boosting request is generated by the control of the integrated ECU 31 based on information regarding the driving situation of the own vehicle), the first and second shut-off valves 60a and 60b are closed and shut off, while the third shut-off valve 62 is opened. The primary hydraulic pressure generated in the master cylinder 34 is released from the master cylinder 34 to a stroke simulator 64. As a result, even when the first and second shut-off valves 60a and 60b are closed and shut off, the primary hydraulic pressure is buffered, and the stroke of the brake pedal 12 occurs in accordance with the driver's braking operation.

In the vehicle braking system 11 under the normal conditions, the motor cylinder device 16 generates a secondary hydraulic pressure according to the driver's braking operation in a state where communication between the master cylinder device 14 and the motor cylinder device 16 is closed and cut off using the first and second shut-off valves 60a and 60b. The secondary hydraulic pressure thus generated is used to operate the hydraulic braking mechanism 24.

In the vehicle braking system 11, when the driver performs a braking operation under an abnormal condition where the motor cylinder device 16, ESB-ECU 29, and integrated ECU 31 do not operate normally, the existing hydraulic brake system is activated.

In the vehicle braking system 11 under the abnormal condition, when the driver performs a braking operation, the third shut-off valve 62 is closed with the first and second shut-off valves 60a and 60b open. The primary hydraulic pressure generated in the master cylinder 34 is transmitted to the hydraulic braking mechanism 24 through required hydraulic passages 22a to 22f, thus activating the hydraulic braking mechanism 24.

### [Configuration Including Peripherals of ESB-ECU 29 and Integrated ECU 31]

Next, with reference to FIG. 2, description is given of a configuration including peripherals of the electrical servo brake (ESB)-ECU 29 and integrated ECU 31 provided in the vehicle braking system 11. FIG. 2 is a block diagram showing the configuration including the peripherals of the ESB-ECU 29 and integrated ECU 31 provided in the vehicle braking system 11.

As shown in FIG. 2, the vehicle braking system 11 includes the ESB-ECU 29 and the integrated ECU 31.

The ESB-ECU 29 and the integrated ECU 31 are connected so as to be able to communicate information to each other through a communication medium 33, as shown in FIG. 2. A controller area network (CAN) constructed in the own vehicle can be suitably used, for example, as the communication medium 33. The CAN is a multiplexed serial communication network used for information communication between on-vehicle devices.

### [Configuration of ESB-ECU 29]

As shown in FIG. 2, an ignition key switch (hereinafter abbreviated as “IG key switch”) 121, a vehicle speed sensor 123, a brake pedal sensor 125, a Hall sensor 127, and brake hydraulic pressure sensors Pm, Pp, and Ph are connected as an input system to the ESB-ECU 29.

The IG key switch 121 is a switch operated to supply a power supply voltage to each of the electrical components mounted on the own vehicle through an on-vehicle battery (not shown). When the IG key switch 121 is turned on, the power supply voltage is supplied to the ESB-ECU 29, and the ESB-ECU 29 is activated.

The vehicle speed sensor 123 has a function to detect the vehicle speed of the own vehicle. Such information on the vehicle speed detected by the vehicle speed sensor 123 is sent to the ESB-ECU 29.

The brake pedal sensor 125 has a function to detect the operation amount (stroke amount) and load (force on pedal) of the brake pedal 12 by the driver. Such information on the operation amount and load of the brake pedal 12 detected by the brake pedal sensor 125 is sent to the ESB-ECU 29.

However, the brake pedal sensor 125 may be a brake SW having a function to simply detect ON (where the brake pedal is stepped on) and OFF (where the brake pedal is not stepped on).

The Hall sensor 127 has a function to detect the rotation angle of the brake motor 72 (current position information in an axial direction of the pair of slave pistons 88a and 88b). Such information on the rotation angle of the brake motor 72 detected by the Hall sensor 127 is sent to the ESB-ECU 29.

The brake hydraulic pressure sensors Pm, Pp, and Ph each have a function to detect an upstream hydraulic pressure of the first shut-off valve 60a, a downstream hydraulic pressure of the second shut-off valve 60b, and a hydraulic pressure in the VSA device 18 in the brake hydraulic system, respectively. The hydraulic pressure information on each part of the brake hydraulic system detected by the brake hydraulic pressure sensors Pm and Pp is sent to the ESB-ECU 29. The hydraulic pressure information detected by the brake hydraulic pressure sensor Ph is sent to the integrated ECU 31 through the ESB-ECU 29 and the communication medium 33, respectively.

As shown in FIG. 2, a brake motor 72 and the first to third shut-off valves 60a, 60b, and 62 are connected, respectively, as an output system to the ESB-ECU 29.

As shown in FIG. 2, the ESB-ECU 29 includes a first information acquisition unit 71, a target braking force calculator 73, a determination unit 75, and a braking controller 77.

The first information acquisition unit 71 has a function to acquire information concerning an on/off operation of the IG key switch 121, information on the vehicle speed detected by the vehicle speed sensor 123, and braking operation information on the braking operation amount and load detected by the brake pedal sensor 125, rotation angle information on the brake motor 72 detected by the Hall sensor 127, information on the braking hydraulic pressure of each part detected by the brake hydraulic pressure sensors Pm, Pp, and Ph, and the like.

The target braking force calculator 73 has a function to calculate a target braking force (target braking torque) according to a required braking amount based on the braking operation amount of the brake pedal 12 by the driver. The target braking force calculator 73 has a function to calculate a target braking force in response to a boosting request (which occurs regardless of the braking operation of the brake pedal 12 by the driver) sent from the integrated ECU 31 through the communication medium 33.

The determination unit 75 has a function to determine whether or not the braking load upon a boosting request is in a steady range.

In principle, the determination unit 75 determines that the braking load is in the steady range when the brake pad temperature Tpad (braking load) upon the boosting request is lower than or equal to the first load threshold Tpadth1 (see FIG. 4).

The determination unit 75 also determines that the braking load is in a caution range above the steady range, when the brake pad temperature Tpad (braking load) upon the boosting request exceeds the first load threshold Tpadth1 (see FIG. 4).

With the brake pad temperature Tpad (braking load) in the steady range, when the brake pad temperature Tpad exceeds the first load threshold Tpadth1, the ESB-ECU 29 determines that the brake pad temperature Tpad has transitioned from the steady range to the caution range.

When the brake pad temperature Tpad is in the caution range, the determination unit 75 determines whether or not the brake pad temperature Tpad upon the boosting request exceeds the second load threshold Tpadth2 (see FIG. 4). With the brake pad temperature Tpad in the caution range, when the brake pad temperature Tpad exceeds the second load threshold Tpadth2, the ESB-ECU 29 determines that the brake pad temperature Tpad (braking load) has transitioned from the caution range to the warning range.

When the brake pad temperature Tpad (braking load) is in the caution range, the determination unit 75 determines whether or not the brake pad temperature Tpad upon the boosting request is less than the third load threshold Tpadth3 (see FIG. 4). With the brake pad temperature Tpad in the caution range, when the brake pad temperature Tpad falls below the third load threshold Tpadth3 (see time t13 in FIG. 4), the ESB-ECU 29 exceptionally determines that the brake pad temperature Tpad has transitioned from the caution range to the steady range.

The braking controller 77 basically has a function to perform braking control for adjusting the magnitude of hydraulic braking force acting on the hydraulic braking mechanism 24 so that the hydraulic braking force follows the target braking force based on the braking operation by the driver.

When the brake pad temperature Tpad upon the boosting request does not exceed the first load threshold Tpadth1, that is, when the braking load upon the required boosting request is in the steady range, the braking controller 77 executes silent control using the second valve closing transient characteristic associated with the first and second shut-off valves 60a and 60b, starting from the point of occurrence of the boosting request (see time t1 in FIG. 4), assuming that there is a low probability of the braking performance evaluation system erroneously evaluating the braking performance as poor.

On the other hand, when the brake pad temperature Tpad upon the boosting request exceeds the first load threshold Tpadth1, that is, when the braking load upon a first boosting request is in the caution range, the braking controller 77 executes non-silent control using the first valve closing transient characteristic associated with the first and second shut-off valves 60a and 60b, starting from the point of occurrence of the first boosting request (see time t7 and time t12 in FIG. 4), assuming that there is a high probability of the braking performance evaluation system erroneously evaluating the braking performance as poor.

The ESB-ECU 29 is configured using a microcomputer including a central processing unit (CPU), a read-only memory (ROM), a random access memory (RAM), and the like. This microcomputer reads and executes programs and data stored in the ROM to perform execution control of various functions of the ESB-ECU 29, including a various information acquisition function, a target braking force calculation function, a function to determine the magnitude of braking load related to the vehicle braking system 11 upon a required boosting request, and a function to perform braking control to adjust the magnitude of hydraulic braking force.

### [Configuration of Integrated ECU 31]

As shown in FIG. 2, a radar 151, a camera 153, a wheel speed sensor 155, an accelerator pedal sensor 157, a yaw rate sensor 159, a G sensor 161, and a pad temperature sensor 163 are connected as an input system to the integrated ECU 31.

A laser radar, a microwave radar, a millimeter wave radar, an ultrasonic radar, and the like can be used as appropriate, for example, as the radar 151. The radar 151 is installed behind a front grill of the own vehicle. Target distribution information around the own vehicle obtained by the radar 151 is sent to the integrated ECU 31.

The camera 153 has an optical axis tilted diagonally downward in front of the own vehicle, and has a function to capture images in the traveling direction of the own vehicle. A complementary metal oxide semiconductor (CMOS) camera, a charge coupled device (CCD) camera, or the like can be used as appropriate, for example, as the camera 153. The camera 153 is provided in the upper center of a windshield of the own vehicle. The traveling direction image information of the own vehicle obtained by the camera 153 is sent to the integrated ECU 31 as an image signal generated by an interlace system such as national television standards committee (NTSC), for example.

The wheel speed sensor 155 has a function to detect the rotational speed (wheel speed) of each wheel provided on the own vehicle. The wheel speed information on each wheel detected by the wheel speed sensor 155 is sent to the integrated ECU 31.

The accelerator pedal sensor 157 has a function to detect the operation amount (stroke amount) of the accelerator pedal by the driver. The accelerator pedal operation amount information detected by the accelerator pedal sensor 157 is sent to the integrated ECU 31.

The yaw rate sensor 159 has a function to detect a yaw rate in the own vehicle. The yaw rate information detected by the yaw rate sensor 159 is sent to the integrated ECU 31.

The G sensor 161 has a function to detect longitudinal G (longitudinal acceleration) and lateral G (lateral acceleration) in the own vehicle. The G information detected by the G sensor 161 is sent to the integrated ECU 31.

The pad temperature sensor 163 is provided close to a brake pad (not shown) and has a function to detect the brake pad temperature Tpad caused by frictional braking. The brake pad temperature Tpad is correlated with the braking state of the own vehicle. Therefore, in the present invention, the brake pad temperature Tpad is used as an index to determine the braking performance of the own vehicle. Such information on the brake pad temperature Tpad (braking performance information) detected by the pad temperature sensor 163 is sent to the integrated ECU 31.

As shown in FIG. 2, an alarm device 76 and a pump motor 79 are connected as an output system to the integrated ECU 31.

The alarm device 76 has a function to issue an alarm by stimulating the driver's sense of hearing, vision, touch, and the like when the braking load of the own vehicle is so high as in the warning range (Tpad>Tpadth2), for example.

The pump motor 79 is rotationally driven based on a braking control signal generated by the integrated ECU 31 when ABS control operation is required, for example. By driving the pump 135 (see FIG. 1) in conjunction with the rotational driving of the pump motor 79, the pump motor 79 can mainly adjust the increase or decrease of the secondary hydraulic pressure.

Next, an internal configuration of the integrated ECU 31 will be described.

A second information acquisition unit 171 has a function to acquire various information including the target distribution information detected by the radar 151, traveling direction image information captured by the camera 153, wheel speed information detected by the wheel speed sensor 155, acceleration/deceleration operation amount information of the accelerator pedal detected by the accelerator pedal sensor 157, yaw rate information detected by the yaw rate sensor 159, G information detected by the G sensor 161, and brake pad temperature Tpad detected by the pad temperature sensor 163.

The second information acquisition unit 171 also has a function to acquire the information sent from the ESB-ECU 29 through the communication medium 33, including the vehicle speed information detected by the vehicle speed sensor 123 and the information on operation amount and load of the brake pedal 12 detected by the brake pedal sensor 125.

An operation unit 173 has a function to determine, by operation, a slip rate (slip information) for each wheel based on the vehicle speed information acquired by the second information acquisition unit 171 and the wheel speed information on each wheel. The slip information on each wheel obtained by the operation unit 173 is appropriately referred to by an integrated controller 175 to determine whether to activate the ABS control.

The integrated controller 175 basically determines whether to activate the ABS control, based on the slip rate information on each wheel obtained by the operation unit 173, and the like. When it is determined that the ABS control is to be activated, the integrated controller 175 performs braking control to periodically increase and decrease the braking force for each wheel by exerting the braking fluid pressure adjustment function of the VSA device 18 so as to suppress slippage of each wheel.

Based on various information including the target distribution information detected by the radar 151, traveling direction image information captured by the camera 153, and vehicle speed information detected by the vehicle speed sensor 123, the integrated controller 175 performs constant speed driving control to cause the vehicle to travel at a constant speed based on a preset vehicle speed and adaptive cruise control (ACC) including following travel control to cause the vehicle to travel following a preceding vehicle traveling ahead in the traveling direction in the traveling lane of the own vehicle while maintaining an inter-vehicle distance set for the preceding vehicle.

Specifically, the integrated controller 175 performs the adaptive cruise control (ACC) of the own vehicle, including acceleration control and deceleration control, without the need for the driver to operate the accelerator pedal or brake pedal while maintaining the vehicle speed of the own vehicle within the target vehicle speed range and maintaining the distance from the preceding vehicle at the set inter-vehicle distance.

The integrated ECU 31 is configured using a microcomputer including a central processing unit (CPU), a read-only memory (ROM), a random access memory (RAM), and the like. This microcomputer reads and executes programs and data stored in the ROM to perform execution control of various functions of the integrated ECU 31, including a various information acquisition function, a function to obtain slip information on each wheel by operation, an ABS control function, and an adaptive cruise control (ACC) function.

### [Schematic Operations of Vehicle Braking System 11]

Next, schematic operations of the vehicle braking system 11 will be described with reference to FIG. 3. FIG. 3 is a flowchart for explaining the operations of the vehicle braking system 11.

However, it is assumed that the IG key switch 121 is always on. It is also assumed that the brake pad temperature Tpad has a value belonging to a steady range.

In step S11 shown in FIG. 3, the second information acquisition unit 171 of the integrated ECU 31 acquires various information including the target distribution information detected by the radar 151, traveling direction image information captured by the camera 153, wheel speed information detected by the wheel speed sensor 155, accelerator pedal acceleration/deceleration operation amount information detected by the accelerator pedal sensor 157, yaw rate information detected by the yaw rate sensor 159, G information detected by the G sensor 161, and brake pad temperature Tpad detected by the pad temperature sensor 163.

In step S12, the integrated ECU 31 checks if there is a boosting request based on adaptive cruise control (ACC). When it is not determined that there is a boosting request (No in step S12), the integrated ECU 31 returns the processing flow to step S11.

When it is determined that there is a boosting request (Yes in step S12), on the other hand, the integrated ECU 31 sends information about the boosting request and the brake pad temperature Tpad to the ESB-ECU 29, and advances the processing flow to the next step S13.

In step S13, the determination unit 75 of the ESB-ECU 29 determines whether or not the brake pad temperature Tpad upon the boosting request exceeds the first load threshold Tpadth1 (see FIG. 4).

When it is determined in step S13 that the brake pad temperature Tpad upon the boosting request does not exceed the first load threshold Tpadth1 (the braking load upon the boosting request is in the steady range) (No in step S13), the ESB-ECU 29 considers that there is a low probability of the braking performance evaluation system erroneously evaluating the braking performance as poor, and advances the processing flow to the next step S14.

When it is determined in step S13 that the brake pad temperature Tpad upon the boosting request exceeds the first load threshold Tpadth1 (the braking load upon the boosting request is in the caution range) (No in step S13), on the other hand, the ESB-ECU 29 considers that there is a high probability of the braking performance evaluation system erroneously evaluating the braking performance as poor, and advances the processing flow to the next step S15.

In step S14, the braking controller 77 of the ESB-ECU 29 executes silent control using the second valve closing transient characteristic of the first and second shut-off valves 60a and 60b, starting from the point of occurrence of the boosting request (see time t1 in FIG. 4), when the braking load upon the boosting request is in the steady range. A specific example of the silent control will be described in detail later.

In step S15, the braking controller 77 of the ESB-ECU 29 executes non-silent control using the first valve closing transient characteristic of the first and second shut-off valves 60a and 60b, starting from the point of occurrence of the first boosting request (see time t7 and time t12 in FIG. 4), when the braking load upon the boosting request is in the caution range. A specific example of the non-silent control will be described in detail later.

When the processing in step S14 or S15 is completed, the ESB-ECU 29 and the integrated ECU 31 terminate a series of processes related to braking control upon a boosting request.

### [Detailed Operations of Vehicle Braking System 11]

Next, detailed operations of the vehicle braking system 11 will be described with reference to FIG. 4.

FIG. 4 is a time chart for explaining the operations of the vehicle braking system 11. Part (a) of FIG. 4 shows changes in occurrence of boosting request over time. Part (b) of FIG. 4 shows changes in brake pad temperature Tpad over time. Part (c) of FIG. 4 shows changes in braking load determination results over time. Part (d) of FIG. 4 shows temporal characteristics (valve closing transient characteristics) of the solenoid valve drive output for the first and second shut-off valves 60a and 60b.

At time t1 in FIG. 4, a boosting request occurs based on adaptive cruise control (ACC). The boosting request occurs during the period from time t1 to t5 (see Part (a) of FIG. 4). At the same time t1, the brake pad temperature Tpad is in a steady range (Tpad<Tpadth1). At the same time t1, the braking load determination result is that the load is small. Therefore, in response to the boosting request that has occurred at the same time t1, the ESB-ECU 29 executes the silent control using the second valve closing transient characteristic of the first and second shut-off valves 60a and 60b, starting from the point of occurrence of the boosting request (time t1) during the period from time t1 to t5.

The solenoid valve drive output (predetermined second valve closing transient characteristic) shown in Part (d) of FIG. 4 sharply rises from 0 (output value to open the solenoid valves) to a first output value P1 (output value to set the solenoid valves ready to be closed) at the same time t1, and then rises slowly and linearly from the first output value P1 to a second output value P2 (output value to set the solenoid valve in the closed state) during the period from time t1 to t3. The period from time t1 to t3 is a characteristic portion of the second valve closing transient characteristic related to the silent control. An operating sound (noise) caused by closing of the first and second shut-off valves 60a and 60b is thus suppressed as much as possible.

A third output value P3 (predetermined output value for maintaining the solenoid valves in the closed state) is maintained in a predetermined period from time t3 to t4. In any period from time t4 to t5 (remaining period after subtracting a predetermined period from time t1 to t4 from the period from time t1 to t5 during which the required boosting request occurs), a predetermined output value that can maintain the solenoid valves in the closed state is maintained. At time t5, as the required boosting request disappears, the solenoid valve drive output sharply falls from the first output value P1 to zero.

At time t7 in FIG. 4, a boosting request occurs based on ACC. A boosting request occurs in a period from time t7 to t11 (see Part (a) of FIG. 4). At the same time t7, the brake pad temperature Tpad is in the caution range (Tpad>Tpadth1). At the same time t7, the braking load determination result is that the load is large. Therefore, in response to the boosting request that has occurred at the same time t7, the ESB-ECU 29 executes the non-silent control using the first valve closing transient characteristic of the first and second shut-off valves 60a and 60b, starting from the point of occurrence of the boosting request (time t7) in the period from time t7 to t11.

The solenoid valve drive output (non-predetermined first valve closing transient characteristic) shown in Part (d) of FIG. 4 sharply rises from 0 (output value to open the solenoid valves) to the first output value P1 (output value to set the solenoid valves ready to be closed) at the same time t7, and then rises steeply and linearly from the first output value P1 to the second output value P2 (output value to set the solenoid valve in the closed state) in the period from time t7 to t8. The period from time t7 to t8 is a characteristic portion of the first valve closing transient characteristic related to the non-silent control. In particular, the period from time t7 to t8 is set to be shorter than the period from time t1 to t3. Therefore, even when the braking performance evaluation system is adopted, the braking performance evaluation system is prevented as much as possible from erroneously evaluating the braking performance as poor.

The third output value P3 (predetermined output value for maintaining the solenoid valves in the closed state) is maintained in a predetermined period from time t8 to t10. In any period from time t10 to t11 (remaining period after subtracting a predetermined period from time t7 to t10 from the period from time t7 to t11 during which the required boosting request occurs), a predetermined output value that can maintain the solenoid valves in the closed state is maintained. At time t11, as the required boosting request disappears, the solenoid valve drive output sharply falls from the first output value P1 to zero.

At time t12 in FIG. 4, a boosting request occurs based on ACC. A boosting request occurs in a period from time t12 to t16 (see Part (a) of FIG. 4). At the same time t12, the brake pad temperature Tpad is in the caution range (Tpad>Tpadth3). At the same time t12, the braking load determination result is that the load is large. Therefore, in response to the boosting request that has occurred at the same time t12, the ESB-ECU 29 executes the non-silent control using the first valve closing transient characteristic of the first and second shut-off valves 60a and 60b, starting from the point of occurrence of the boosting request (time t12) in the period from time t12 to t16.

The solenoid valve drive output (non-predetermined first valve closing transient characteristic) shown in Part (d) of FIG. 4 sharply rises from 0 (output value to open the solenoid valves) to the first output value P1 (output value to set the solenoid valves ready to be closed) at the same time t12, and then rises steeply and linearly from the first output value P1 to the second output value P2 (output value to set the solenoid valve in the closed state) in the period from time t12 to t14. The period from time t12 to t14 is a characteristic portion of the first valve closing transient characteristic related to the non-silent control. In particular, the period from time t12 to t14 is set to be shorter than the period from time t1 to t3. Therefore, as with the period from time t7 to t11, even when the braking performance evaluation system is adopted, the braking performance evaluation system is prevented as much as possible from erroneously evaluating the braking performance as poor.

The third output value P3 (predetermined output value for maintaining the solenoid valves in the closed state) is maintained in a predetermined period from time t14 to t15. In any period from time t15 to t16 (remaining period after subtracting a predetermined period from time t12 to t15 from the period from time t12 to t16 during which the required boosting request occurs), a predetermined output value that can maintain the solenoid valves in the closed state is maintained. At time t16, as the required boosting request disappears, the solenoid valve drive output sharply falls from the first output value P1 to zero.

At time t2 shown in FIG. 4, the brake pad temperature Tpad in the steady range exceeds the first load threshold Tpadth1. As a result, at the same time t2, the braking load transitions from the steady range to the caution range.

At time t13 shown in FIG. 4, the brake pad temperature Tpad in the caution range falls below the third load threshold Tpadth3. As a result, at the same time t13, the braking load transitions from the caution range to the steady range.

At time t6 shown in FIG. 4, the brake pad temperature Tpad in the caution range exceeds the second load threshold Tpadth2. As a result, at the same time t6, the braking load transitions from the caution range to the warning range. Note that when the braking load (brake pad temperature Tpad) is in the warning range, the braking performance evaluation system determines that the vehicle braking system 11 has poor braking performance, considering that the braking load is at its maximum. A poor braking performance alarm is then issued to passengers.

### [Advantageous Effects of Vehicle Braking System 11]

Next, advantageous effects of the vehicle braking system 11 will be described with reference to FIG. 5.

FIG. 5 is an explanatory diagram showing a comparison between an operation of a vehicle braking system according to a comparative example of the present invention and the operation of the vehicle braking system 11 according to an example of the present invention.

A vehicle braking system 11 based on a first aspect applies braking force to the own vehicle and includes: a master cylinder device 14 that generates a primary hydraulic pressure according to a braking operation by a driver; a motor cylinder device 16 that generates a secondary hydraulic pressure according to a target braking force by activating a brake motor 72 and a pump motor 79 (electric actuator) in response to a required boosting request; normally-open first and second shut-off valves 60a and 60b (solenoid valves) which are provided in hydraulic pressure passages 22a and 22d that communicate between the master cylinder device 14 and the motor cylinder device 16, and operate to open or close the hydraulic pressure passages; and a braking controller (controller) 77 that performs driving control to close the solenoid valves based on the required boosting request.

The vehicle braking system 11 further includes a determination unit 75 that determines whether or not a brake pad temperature Tpad (braking load) upon a boosting request is in a steady range. When the brake pad temperature Tpad (braking load) upon the boosting request exceeds a predetermined first load threshold Tpadth1, the determination unit 75 determines that the braking load is in a caution range above the steady range.

When the brake pad temperature Tpad (braking load) upon the boosting request is in the caution range, the braking controller 77 executes braking control (non-silent control) using a first valve closing transient characteristic to close the solenoid valves from the point of occurrence of the boosting request.

The vehicle braking system 11 employs a configuration in which the first valve closing transient characteristic is set steeper than the second valve closing transient characteristic to close the solenoid valves from the point of occurrence of the boosting request when the braking load upon the boosting request is in the steady range.

According to the vehicle braking system 11 based on the first aspect, the braking controller 77 executes the braking control using the first valve closing transient characteristic (for non-silent control) that is set steeper than the second valve closing transient characteristic (for silent control) when the brake pad temperature Tpad (braking load) upon the boosting request is in the caution range (Tpad>Tpadth1). This makes it possible, even when the braking performance evaluation system is adopted, to prevent as much as possible the braking performance evaluation system from erroneously evaluating the braking performance as poor.

Here, the vehicle braking system 11 employs a braking performance evaluation system that carries out braking performance evaluation based on the degree of consistency related to the correlation between a braking operation amount (stroke amount) and the generated braking force (braking hydraulic pressure).

This braking performance evaluation system uses the correlation between the stroke amount and the braking hydraulic pressure under the common condition that the braking load upon a required boosting request is large (Tpad>Tpadth1), as shown in FIG. 5. As examples of such correlation characteristics, the dotted line in FIG. 5 represents a standard characteristic, the dashed line in FIG. 5 represents a comparative example characteristic with silent control, and the solid line in FIG. 5 represents an example characteristic with non-silent control.

The comparative example characteristic with silent control shows a weakness of silent control (a time delay in shutting off the hydraulic passage causes liquid loss in the secondary hydraulic pressure and the comparative example characteristic shifts to the right in FIG. 5 compared to the standard characteristic). In this event, braking performance evaluation by the braking performance evaluation system results in erroneously evaluating the braking performance as poor especially in a portion where the stroke amount is large (the boosting request is large).

On the other hand, the example characteristic with non-silent control eliminates the weaknesses of the silent control, thus preventing the situation where the example characteristic shifts to the right in FIG. 5 with respect to the standard characteristic. Therefore, the braking performance evaluation by the braking performance evaluation system does not result in erroneously evaluating the braking performance as poor in the portion where the stroke amount is large (the boosting request is large).

A vehicle braking system 11 based on a second aspect is the vehicle braking system 11 based on the first aspect, in which a configuration may be adopted in which the boosting request is a boosting request based on the target braking force generated regardless of a braking operation by the driver.

Here, the boosting request is not particularly limited, but may include, for example, a boosting request based on adaptive cruise control (ACC).

The vehicle braking system 11 based on the second aspect makes it possible to provide a braking control technique that can be quickly applied to so-called automated driving.

A vehicle braking system 11 based on a third aspect is the vehicle braking system 11 based on the first or second aspect, in which the determination unit 75 further determines whether or not the brake pad temperature Tpad (braking load) upon the boosting request exceeds a predetermined second load threshold Tpadth2. The second load threshold Tpadth2 is set higher than the first load threshold Tpadth1.

When the brake pad temperature Tpad (braking load) upon the boosting request exceeds the second load threshold Tpadth2, the determination unit 75 determines that the brake pad temperature Tpad (braking load) is in a warning range.

Here, as shown in FIG. 4, the second load threshold Tpadth2 is a threshold that serves as a reference for determining, when the brake pad temperature Tpad is in the caution range, whether or not the brake pad temperature Tpad has transitioned from the caution range to a warning range (stricter than the caution range) where passengers need to be warned. The brake pad temperature Tpad is used as an evaluation parameter in the braking performance evaluation system. When the brake pad temperature Tpad exceeds the second load threshold Tpadth2, the braking performance evaluation system determines that the vehicle braking system 11 has poor braking performance, considering that the braking load is at its maximum. On the other hand, when the brake pad temperature Tpad exceeds the first load threshold Tpadth1 (Tpadth1<Tpadth2), the vehicle braking system 11 according to the embodiment prohibits the predetermined silent control and executes non-silent control, considering that the braking load is large.

According to the vehicle braking system 11 based on the third aspect, when the brake pad temperature Tpad (braking load) upon the boosting request exceeds the second load threshold Tpadth2 (Tpad>Tpadth2>Tpadth1), the determination unit 75 determines that the brake pad temperature Tpad (braking load) is in the warning range. This makes it possible to appropriately perform braking performance evaluation based on the brake pad temperature Tpad (braking load), in addition to the advantageous effects of the vehicle braking system 11 based on the first or second aspect.

A vehicle braking system 11 based on a fourth aspect is the vehicle braking system 11 based on the third aspect, in which a configuration may be adopted in which magnitude evaluation of the braking load upon a boosting request is performed based on a correlation value of the brake pad temperature Tpad, and the first load threshold Tpadth1 and the second load threshold Tpadth2 may be defined based on the correlation value of the brake pad temperature Tpad.

Note that the correlation value of the brake pad temperature Tpad is a concept that includes both a detected value of the brake pad temperature Tpad and an estimated value of the brake pad temperature Tpad.

According to the vehicle braking system 11 based on the fourth aspect, the magnitude evaluation of the braking load upon a boosting request is performed based on the correlation value of the brake pad temperature Tpad, and the first load threshold Tpadth1 and the second load threshold Tpadth2 may be defined based on the correlation value of the brake pad temperature Tpad. This makes it possible to appropriately perform the magnitude evaluation of the braking load based on the correlation value of the brake pad temperature Tpad and a comparison result between the first load threshold Tpadth1 and the second load threshold Tpadth2, in addition to the advantageous effects of the vehicle braking system 11 based on the first or second aspect.

A vehicle braking system 11 based on a fifth aspect is the vehicle braking system 11 based on any one of the first to fourth aspects, in which the determination unit 75 further determines whether or not the brake pad temperature Tpad (braking load) upon a boosting request when the braking load is in the caution range is less than a predetermined third load threshold Tpadth3. The third load threshold Tpadth3 is set lower than the first load threshold Tpadth1. When the brake pad temperature Tpad (braking load) upon the boosting request when the braking load is in the caution range is less than the third load threshold Tpadth3, the determination unit 75 determines that the brake pad temperature Tpad (braking load) has transitioned from the caution range to the steady range.

As shown in FIG. 4, the first load threshold Tpadth1 is a threshold that serves as a reference for determining, when the brake pad temperature Tpad (braking load) is in the steady range, whether or not the brake pad temperature Tpad has transitioned from the steady range to the caution range.

As shown in FIG. 4, the third load threshold Tpadth3 is a threshold that serves as a reference for determining, when the brake pad temperature Tpad is in the caution range, whether or not the brake pad temperature Tpad has transitioned from the caution range to the steady range.

The third load threshold Tpadth3, which serves as the reference for determining whether or not the brake pad temperature Tpad has transitioned from the caution range to the steady range, is set to be smaller than the first load threshold Tpadth1, which serves as the reference for determining whether or not the brake pad temperature Tpad has transitioned from the steady range to the caution range. This is to prevent the occurrence of a so-called hunting phenomenon that the brake pad temperature Tpad transitions between the steady range and the caution range in a short period of time.

According to the vehicle braking system 11 based on the fifth aspect, when the brake pad temperature Tpad (braking load) upon the boosting request when the braking load is in the caution range is less than the third load threshold Tpadth3, the determination unit 75 determines that the brake pad temperature Tpad (braking load) has transitioned from the caution range to the steady range. This makes it possible to avoid the so-called hunting phenomenon that the brake pad temperature Tpad transitions between the steady range and the caution range in a short period of time, in addition to the advantageous effects of the vehicle braking system 11 based on the first or second aspect.

### OTHER EMBODIMENTS

The plurality of embodiments described above are examples of implementation of the present invention. Therefore, the technical scope of the present invention should not be construed as being limited by these examples. This is because the present invention can be implemented in various forms without departing from its gist or main features.

For example, although an example has been described in which the various functions of the vehicle braking system 11 are divided into the ESB-ECU 29 and the integrated ECU 31, the present invention is not limited to this example.

The present invention may adopt a configuration in which the various functions of the vehicle braking system 11 are collectively provided in one ECU.

What is claimed is:

1. A vehicle braking system for applying braking force to an own vehicle, comprising:
a master cylinder device that generates a primary hydraulic pressure according to a braking operation by a driver;
a motor cylinder device that generates a secondary hydraulic pressure according to a target braking force by activating an electric actuator in response to a required boosting request;
a normally-open solenoid valve which is provided in a hydraulic pressure passage that communicates between the master cylinder device and the motor cylinder device, and operates to open or close the hydraulic pressure passages; and
a controller that performs driving control to close the solenoid valve based on the required boosting request,
the vehicle braking system further comprising:
a determination unit that determines whether or not a braking load upon a boosting request is in a steady range, wherein
when the braking load upon the boosting request exceeds a predetermined first load threshold, the determination unit determines that the braking load is in a caution range above the steady range,
when the braking load upon the boosting request is in the caution range, the controller executes braking control using a first valve closing transient characteristic to close the solenoid valve from the point of occurrence of the boosting request, and
the first valve closing transient characteristic is set steeper than a second valve closing transient characteristic to close the solenoid valve from the point of occurrence of the boosting request when the braking load upon the boosting request is in the steady range.

2. The vehicle braking system according to claim 1, wherein
the boosting request is a boosting request based on the target braking force generated regardless of a braking operation by a driver.

3. The vehicle braking system according to claim 1, wherein
the determination unit further determines whether or not the braking load upon the boosting request exceeds a predetermined second load threshold,
the second load threshold is set higher than the first load threshold, and
when the braking load upon the boosting request exceeds the second load threshold, the determination unit determines that the braking load is in a warning range above the caution range.

4. The vehicle braking system according to claim 3, wherein
magnitude evaluation of the braking load upon a boosting request is performed based on a correlation value of the brake pad temperature, and the first load threshold and the second load threshold are defined based on the correlation value of the brake pad temperature.

5. The vehicle braking system according to claim 1, wherein
the determination unit further determines whether or not the braking load upon a boosting request when the braking load is in the caution range is less than a predetermined third load threshold,
the third load threshold is set lower than the first load threshold, and
when the braking load upon the boosting request when the braking load is in the caution range is less than the third load threshold, the determination unit determines that the braking load has transitioned from the caution range to the steady range.
